(19) United States
(12) Patent Application Publication
(10) Pub. No.: US 2003/0017253 A1
(43) Pub. Date: Jan. 23, 2003

(54) Fabricated snack comprising added potato fiber

(75) Inventors: Maria Dolores Martinez-Serna Villagran, Mason, OH (US); Brent Ray Johnson, Minneapolis, MN (US); Louis Bernard Vonderhaar, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Co.

(21) Appl. No.: 10/185,846

(22) Filed: Jun. 27, 2002

Related U.S. Application Data
(60) Provisional application No. 60/302,905, filed on Jul. 3, 2001.

(51) Int. Cl. A23L 1/216

(52) U.S. Cl. 426/637

(57) ABSTRACT

A snack dough that can be sheeted, shaped, and fried to produce a snack product having an expanded texture, decreased external foaminess, and a lighter eating quality. In one embodiment, the dough comprises: (a) from about 0.1% to about 4% added potato fiber; (b) from about 35% to about 85% starch-based material; and (c) from about 10% to about 50% added water. In another embodiment, the dough comprises: (a) from about 0.1% to about 30% added potato fiber, wherein said added potato fiber comprises from about 30% to about 80% starch; (b) from about 35% to about 85% starch-based material; and (c) from about 10% to about 50% added water. The dough can be formed into snack pieces and cooked to form a snack product, preferably fabricated chips. Preferably, the added potato fiber comprises from about 2% to about 13% protein. The preferred starch-based material comprises from about 25% to about 100% potato flakes. Preferably, the fabricated chip is cooked by frying in oil.

### CROSS REFERENCE TO RELATED APPLICATION

This application claims the benefit of priority to U.S. Provisional Application Serial No. 60/302,905, filed Jul. 3, 2001, which is herein incorporated by reference.

### TECHNICAL FIELD

The present invention relates to snack doughs and to snack products that can be formed from the snack doughs.

### BACKGROUND

The preparation of food products from a dough based on dehydrated potato products is well known. Snacks such as fabricated chips are among the most popular products that have been prepared from such doughs. The advantages of preparing such food products from a dough rather than from sliced, whole potatoes include homogeneity or uniformity in the end food products and the ability to more closely control the separate steps involved in the preparation of the food products.

When food products of this type are prepared from doughs based on dehydrated potato products and water, however, low moisture levels in the dough can prevent the formation of a continuous, smooth, extensible dough sheet. This can hinder subsequent expansion of the dough pieces during frying, even if the dough can be processed into a shaped form. It can also produce a dough that is less elastic than desirable. In addition, low moisture sheeted doughs tend to produce a denser and glassier texture in the resulting snack products.

Accordingly, it would be desirable to provide a snack dough that can be sheeted, shaped, and fried to produce a snack product having an expanded texture, decreased external foaminess (surface bubble formation), and a lighter eating quality.

### SUMMARY

The present invention provides a snack dough that can be sheeted, shaped, and fried to produce a snack product having an expanded texture, decreased external foaminess, and a lighter eating quality.

In one embodiment, the dough comprises:

(a) from about 0.1% to about 4% added potato fiber;

(b) from about 35% to about 85% starch-based material; and

(c) from about 10% to about 50% added water.

In another embodiment, the dough comprises:

(a) from about 0.1% to about 30% added potato fiber, wherein said added potato fiber comprises from about 30% to about 80% starch;

(b) from about 35% to about 85% starch-based material; and

(c) from about 10% to about 50% added water.

The dough can be formed into snack pieces and cooked to form a snack product, preferably fabricated chips. Preferably, the added potato fiber comprises from about 2% to about 13% protein. The preferred starch-based material comprises from about 25% to about 100% potato flakes. Preferably, the fabricated chip is cooked by frying in oil.

### DETAILED DESCRIPTION

A. Definitions

As used herein, “dehydrated potato products” includes, but is not limited to, potato flakes, potato flanules, potato granules, potato agglomerates, any other dehydrated potato material (e.g., such as baked mashed potatoes), and mixtures thereof.

As used herein, intact sheets of flakes and sheet sections are included in the term “flakes.”

As used herein “flanules” refers to dehydrated potato products described in U.S. patent application Ser. No. 09/175,138, “Dough Compositions Made With Dehydrated Potato Flanules,” filed Oct. 19, 1998 by Villagran et al.

As used herein “sheetable dough” is a dough capable of being placed on a smooth surface and rolled to the desired final thickness without tearing or forming holes. Sheetable dough can also include dough that is capable of being formed into a sheet through an extrusion process.

As used herein, “starch” refers to a native or an unmodified carbohydrate polymer having repeating anhydroglucose units derived from materials such as, but not limited to, wheat, corn, tapioca, sago, rice, potato, oat, barley, and amaranth, and to modified starches including but not limited to hydrolyzed starches such as maltodextrins, high amylose corn maize, high amylopectin corn maize, pure amylose, chemically substituted starches, crosslinked starches, and mixtures thereof. “Starch” also includes dried potato products that are added into or back into the mash.

As used herein, “starch-based material” refers to high polymeric carbohydrates composed of glucopyranose units, in either natural, dehydrated (e.g., flakes, granules, meal) or flour form. Starch-based material can include, but is not limited to, potato flour, potato granules, potato flanules, potato flakes, corn flour, masa corn flour, corn grits, corn meal, rice flour, buckwheat flour, oat flour, bean flour, barley flour, tapioca, and mixtures thereof. For example, the starch-based material can be derived from tubers, legumes, grain, or mixtures thereof.

As used herein, “modified starch” refers to starch that has been physically or chemically altered to improve its functional characteristics. Suitable modified starches include, but are not limited to, pregelatinized starches, low viscosity starches (e.g., dextrins, acid-modified starches, oxidized starches, enzyme modified starches), stabilized starches (e.g., starch esters, starch ethers), cross-linked starches, starch sugars (e.g. glucose syrup, dextrose, isoglucose) and starches that have received a combination of treatments (e.g., cross-linking and gelatinization) and mixtures thereof. (When calculating the level of modified starch according to the present invention, modified starch (e.g., gelatinized starch) that is inherent in dehydrated potato products and other starch-containing ingredients is not included; only the level of modified starch added over and above that contained in other dough ingredients is included in the term “modified starch.”)

As used herein, the term “added water” refers to water that has been added to the dry dough ingredients. Water which is inherently present in the dry dough ingredients, such as in the case of the sources of flour and starches, is not included in the added water.

As used herein, the term “added potato fiber” refers to potato fiber that has been added to the dough ingredients. Potato fiber which is inherently present in the dry dough ingredients, such as in the case of potato flakes, is not included in the added potato fiber.

As used herein, the term “emulsifier” refers to an emulsifier that has been added to the dough ingredients. Emulsifiers which are inherently present in the dough ingredients, such as in the case of potato flakes, are not included in the term emulsifier.

The terms “fat” and “oil” are used interchangeably herein unless otherwise specified. The terms “fat” or “oil” refer to edible fatty substances in a general sense, including natural or synthetic fats and oils consisting essentially of triglycerides, such as, for example soybean oil, corn oil, cottonseed oil, sunflower oil, palm oil, coconut oil, canola oil, fish oil, lard and tallow, which may have been partially or completely hydrogenated or modified otherwise, as well as non-toxic fatty materials having properties similar to triglycerides, herein referred to as non-digestible fats, which materials may be partially or fully indigestible. Reduced calorie fats and edible non-digestible fats, oils or fat substitutes are also included in the terms. Also included in the terms are mixtures of fats and/or oils.

All percentages are by weight unless otherwise specified.

B. Dough Ingredients

1. Added Potato Fiber

In one embodiment, the dough of the present invention comprises from about 0. 1% to about 4%, preferably from about 0.3% to about 2%, and most preferably from about 0.5% to about 1%, added potato fiber.

In another embodiment, the dough of the present invention comprises from about 0. 1% to about 30% added potato fiber wherein the added potato fiber comprises from about 30% to about 80% starch. The optimum level of potato fiber to be used in the dough depends upon the level of starch remaining attached to the fiber. The higher the level of starch remaining attached to the fiber, the higher the level of potato fiber that can be added to the dough to obtain the desired functionality.

Preferably, the added potato fiber comprises from about 2% to about 13% protein, more preferably from about 3% to about 8% protein, and most preferably from about 4% to about 6% protein.

The addition of fiber to fabricated snacks can result in a dense product. This is caused by the ability of the fiber to absorb moisture, which can be difficult to remove during frying. Fabricated snacks made according to the present invention, however, result in products having the desired expanded texture, decreased external foaminess, and lighter eating quality.

Preferred sources of added potato fiber include Paselli FPF® and Paselli FP®, available from Avebe America Inc., Princeton, N.J.

2. Starch-Based Material

The doughs of the present invention comprise starch-based material. The doughs of the present invention can comprise from about 35% to about 85%, preferably from about 50% to about 70%, and more preferably from about 55% to about 65%, starch-based material. The starch-based material can comprise a mixture of starch-containing ingredients, such as potato flour, potato flanules, potato granules, corn flour, masa corn flour, corn grits, corn meal, rice flour, buckwheat flour, rice flour, oat flour, bean flour, and barley flour, as well as modified starches, native starches, and dehydrated starches, starches derived from tubers, legumes and grain, for example cornstarch, wheat starch, rice starch, waxy corn starch, oat starch, cavassa starch, waxy barley, waxy rice starch, glutinous rice starch, rice starch, sweet rice starch, amioca, potato starch, tapioca starch, and mixtures thereof. Suitable starch-based materials disclosed in WO 99/33357, published Jul. 8, 1999 by Gizaw et al., can also be used.

The preferred starch-based material comprises dehydrated potato products, preferably potato flakes. In one embodiment, the starch-based material comprises from about 25% to 100% potato flakes with the balance (from 0 to about 75%) being other starch-containing ingredients. The starch-based material preferably comprises from about 40% to about 90%, more preferably from about 50% to about 80%, and even more preferably about 60% to about 70%, of dehydrated potato products, preferably potato flakes, and from about 10% to about 60%, preferably from about 20% to about 50%, and more preferably from about 30% to about 40%, of another starch-containing ingredient.

3. Added Water

The dough compositions of the present invention comprise from about 10% to about 50% added water, preferably from about 22% to about 40%, and more preferably from about 24% to about 35%, added water. The level of water in flours and starches, which is usually from about 3% to about 12%, is not included in “added water.” However, if other ingredients, such as maltodextrin or corn syrup solids, are added as a solution or syrup, the water in the syrup or solution is included as “added water.” The amount of added water also includes any water used to dissolve or disperse ingredients and includes water present in liquid ingredients.

4. Optional Ingredients

Emulsifier can optionally be added to the dough to aid in its processability. Typically, emulsifier is added to the dough in an amount of from about 0.02% to about 6%, preferably from about 0.1% to about 5%, and more preferably from about 2% to about 4%.

An emulsifier is preferably added to the dough composition prior to sheeting the dough. The emulsifier can be dissolved in a fat or in a polyol fatty acid polyester such as Olean®, available from The Procter and Gamble Company. Suitable emulsifiers include lecithin, mono- and diglycerides, diacetyl tartaric acid esters, propylene glycol mono- and diesters, and polyglycerol. Polyglycerol emulsifiers such as monoesters of polyglycerols, preferably hexapolyglycerols, can be used. Particularly preferred monoglycerides are sold under the trade names of Dimodan available from Danisco, New Century, Kans. and DMG™ 70, available from Archer Daniels Midland Company, Decatur, Ill.

Herbs and spices can be included in the dough. These can include, but are not limited to, dehydrated vegetables, onion, garlic, tarragon, dill, marjoram, sage, basil, thyme, oregano, cumin, cilantro, chili powder, corriander, mustard, mustard seed, celery, carrots, lemon peel, orange peel, savory, rosemary, paprika, cinnamon, curry, cardamon, fennel seeds, bay, laurel, cloves, fennugrek, parsley, turmeric, chives, scallions, leeks, shallots, nutmeg, mace, allspice, cocoa powder, cayenne pepper, bell pepper, and hot peppers, as well as dried fruits. In addition, extractives and oleoresins of herbs and spices may be used.

The dough can optionally include a starch such as a native, modified, or resistant starch. From about 0.1% to about 70%, more preferably from about 5% to about 60%, and most preferably from about 15% to about 40% starch may typically be added. The starch can be derived from tubers, legumes, or grains and can include, but is not limited to, cornstarch, wheat starch, rice starch, waxy corn starch, oat starch, cassava starch, waxy barley, waxy rice starch, glutinous rice starch, rice starch, sweet rice starch, potato starch, tapioca starch, amaranth starch, sago starch, or mixtures thereof. When calculating the level of starch according to the present invention, starch that is inherent in the other ingredients, such as potato flakes, potato flanules, potato granules, and flours, is not included. (The level of starch is that which is added over and above that level inherently present in the other dough ingredients.)

Doughs of the present invention can include modified starch. When calculating the level of modified starch according to the present invention, modified starch (e.g., gelatinized starch) that is inherent in potato flakes, potato flanules, potato granules, and flours is not included. (The level of modified starch is that which is added over and above that level inherently present in the potato flakes, potato flanules, potato granules, and flours.)

Preferably, at least about 0.2% modified starch selected from the group consisting of pregelatinized starches, cross-linked starches, acid modified starches, and mixtures thereof are included to change the texture (i.e. increase the crispiness) of the snack. Preferably, a level of from about 0.2% to about 15%, more preferably from about 1% to about 10%, and even more preferably from about 3% to about 7%, modified starch is used. Particularly preferred modified starches are available from National Starch and Chemical Corporation, Bridgewater, N.J. and are sold under the trade names of N-Lite™ (pregelatinized-crosslinked starch, Ultrasperse-ATm (pregelatinized, waxy corn), N-Creamer™ 46 and Corn PCPF400™ (partially pre-cooked corn meal). Suitable modified starches disclosed in WO 99/33357, published Jul. 8, 1999 by Gizaw et al., may be used.

Hydrolyzed starch is an especially preferred modified starch that can be included in the doughs of the present invention. Hydrolyzed starches are typically included in the dough compositions in an amount of at least about 1%, with a usual range of from about 1% to about 15%, preferably from about 3% to about 12%. Suitable hydrolyzed starches for inclusion in the dough include maltodextrins and corn syrup solids. The hydrolyzed starches for inclusion in the dough have Dextrose Equivalent (D.E.) values of from about 5 to about 30, preferably from about 10 to about 20. Maltrin™ M050, M100, M150, M180, M200, and M250 (available from Grain Processing Corporation, Iowa) are preferred maltodextrins. The D.E. value is a measure of the reducing equivalence of the hydrolyzed starch referenced to dextrose and is expressed as a percentage (on a dry basis). The higher the D.E. value, the higher the dextrose equivalence of the starch.

B. Dough Preparation

1. Preparing the Dough

The doughs of the present invention can be prepared by any suitable method for forming sheetable doughs. Typically, a loose, dry dough is prepared by thoroughly mixing together the ingredients using conventional mixers. Preferably, a pre-blend of the wet ingredients and a pre-blend of the dry ingredients are prepared; the wet pre-blend and the dry pre-blend are then mixed together to form the dough. Hobart® mixers are preferred for batch operations and Turbulizer® mixers are preferred for continuous mixing operations. Alternatively, extruders can be used to mix the dough and to form sheets or shaped pieces.

The sheet strength of the dough correlates to the cohesiveness of the dough and to the ability of the dough to resist developing holes and/or tearing during subsequent processing steps. The higher the sheet strength, the more cohesive and elastic the dough.

The sheet strength of the dough of the present invention increases as the amount of energy input during the dough-making step increases. Factors that can affect energy input include, but are not limited to, mixing conditions, dough sheet formation, and the amount of measurable free amylose.

2. Dough Characteristics

Tensile Strength

The dough rheology of this invention can be measured by monitoring changes in tensile strength (maximum peak force, distance (extensibility), and area under the curve (firmness)). In the fabrication of snacks, the formation of a continuous dough sheet that is cohesive and has the desired level of elasticity is required to obtain the preferred finished product quality.

In general, sheet strength is a measurement of the force (maximum peak) needed to rupture (failure) a piece of dough, and correlates with cohesivess of the dough and the ability of the dough to resist developing holes and/or tearing during subsequent processing steps. Also, in general, tensile strength increases as the amount of energy input during the dough-making step increases. Factors that can affect energy input include, but are not limited to, mixing conditions, dough sheet formation, and the amount of free amylose. Distance is the deformation in mm that the piece of dough stretches before it ruptures; distance correlates to the extensibility of the dough. Area is the area under the curve (force vs. distance) expressed in gf/mm. The distance or deformation correlates to how elastic the dough piece is, and the area corresponds to the firmness of the dough; it also relates to the work required to rupture the dough.

The dough compositions comprising added potato fiber of the present invention exhibit a lower sheet strength in comparison to doughs of the same composition made without the addition of potato fiber. However, the firmness (area) and the extensibility (distance) show higher levels for doughs comprising added potato fiber. This combination of rheological properties makes the dough comprising added potato fiber suitable as a replacement for doughs made with a very high water content, sugar content, or plasticizer content.

The doughs of the present invention preferably have a sheet strength of from about 60 gf to about 300 gf, more preferably from about 70 gf to about 250 gf, and most preferably from about 90 gf to about 160 gf.

The preferred extensibility for doughs of the present invention is from about 15 mm to about 80 mm, more preferably from about 18 mm to about 70 mm, and most preferably from about 20 mm to about 60 mm. The firmness of the dough is preferably from about 200 gf/mm to about 650 gf/mm, more preferably from about 285 gf/mm to about 500 gf/mm, and most preferably from about 300 gf/mm to about 450 gf/mm.

Modulus of Elasticity (G′)

The viscoelastic properties of the dough are important factors in obtaining the structure of the fabricated snacks of the present invention. Since the doughs are relatively non-flowable, an oscillatory test method, as described herein, is used to measure the dough. The viscoelastic properties can be measured using a Control Stress Rheometer. G′ relates to the elasticity of the dough. Doughs comprising added potato fiber show very low levels of elasticity, which indicates that the shape of the dough can be more easily deformed or altered to the desired shape during sheeting and frying.

Doughs used to produce finished products having the desired product structure preferably have a G′ of from about 7 KPa to about 50 KPa, more preferably from about 10 KPa to about 30 KPa, and most preferably from about 10 KPa to about 25 KPa.

C. Fabricated Chip Preparation

Although the present invention will be described primarily in terms of a preferred fabricated chip made from potato flakes, it should be readily apparent to one skilled in the art that the dough of the present invention can be used in the production of any suitable food product, especially snack food products.

The production of a preferred fabricated chip is set forth in detail below.

1. Sheeting

Once prepared, the dough is then formed into a relatively flat, thin sheet. Any method suitable for forming such sheets from starch-based doughs can be used. For example, the sheet can be rolled out between two counter rotating cylindrical rollers to obtain a uniform, relatively thin sheet of dough material. Any conventional sheeting, milling and gauging equipment can be used. The mill rolls should preferably be heated to from about 90° F. (32° C.) to about 135° F. (57° C.). In a preferred embodiment, the mill rolls are kept at two different temperatures, with the front roller being cooler than the back roller. The dough can also be formed into a sheet by extrusion.

Doughs of the present invention are usually formed into a sheet having a thickness of from about 0.015 to about 0.10 inches (from about 0.038 to about 0.25 cm), and preferably to a thickness of from about 0.05 to about 0.10 inches (from about 0.013 to about 0.025 cm), and most preferably from about 0.065 inches to about 0.080 inches (1.65 to 2.03 mm). For rippled (wavy shaped) fabricated chips, the preferred thickness is about 0.75 inches (1.9 mm).

2. Snack Piece Formation

The dough sheet is then formed into snack pieces of a predetermined size and shape. The snack pieces can be formed using any suitable stamping or cutting equipment. The snack pieces can be formed into a variety of shapes. For example, the snack pieces can be in the shape of ovals, squares, circles, a bowtie, a star wheel, or a pin wheel. The pieces can be scored to make rippled chips as described by Dawes et al. in PCT Application No. PCT/US95/07610, published Jan. 25, 1996 as WO 96/01572, which is herein incorporated by reference.

3. Frying

After the snack pieces are formed, they are cooked until crisp to form fabricated chips. The snack pieces can be fried in a fat composition comprising digestible fat, non-digestible fat, or mixtures thereof. For best results, clean frying oil should be used. The free fatty acid content of the oil should preferably be maintained at less than about 1%, more preferably less than about 0.3%, in order to reduce the oil oxidation rate.

Preferably, the snack pieces are fried in oil using a continuous frying method and are constrained during frying. A constrained frying method and apparatus are described in U.S. Pat. No. 3,626,466 issued Dec. 7, 1971 to Liepa. The shaped, constrained snack pieces are passed through the frying medium until they are fried to a crisp state with a final moisture content of from about 0.5% to about 4%, preferably from about 1% to about 2%.

Any other method of frying, such as continuous frying or batch frying of the snack pieces in a non-constrained mode, is also acceptable. For example, the snack pieces can be immersed in the frying fat on a moving belt or basket.

The fabricated chips made from this process typically have from about 20% to about 45%, and preferably from about 25% to about 40%, total fat (i.e., combined non-digestible and digestible fat). If a higher fat level is desired to further improve the flavor or lubricity of the fabricated chips, an oil, such as a triglyceride oil, can be sprayed or applied by any other suitable means onto the fabricated chips when they emerge from the fryer, or when they are removed from the mold used in constrained frying. Preferably, the triglyceride oils applied have an iodine value greater than about 75, and most preferably above about 90. The additionally applied oil can be used to increase the total fat content of the fabricated chips to as high as about 45% total fat. Thus, fabricated chips having various fat contents can be made using this additional step. In a preferred embodiment, at least about 10%, preferably at least about 20%, of the total fat in the finished fabricated chips is topical surface fat.

Oils with characteristic flavor or highly unsaturated oils can be sprayed, tumbled or otherwise applied onto the fabricated chips after frying. Preferably triglyceride oils and non-digestible fats are used as a carrier to disperse flavors and are added topically to the fabricated chips. These include, but are not limited to, butter flavored oils, natural or artificial flavored oils, herb oils, and oils with potato, garlic, or onion flavors added. This allows the introduction of a variety of flavors without having the flavor undergo browning reactions during frying. This method can be used to introduce oils that would ordinarily undergo polymerization or oxidation during the heating necessary to fry the snacks.

### Analytical Methods

Parameters used to characterize elements of the present invention are quantified by particular analytical methods. These methods are described in detail as follows. (All laboratory instruments should be operated according to manufacturers' instructions, as set forth in the instrument operation manuals and instructional materials, unless otherwise indicated.)

Rheological Properties of the Dough

Modulus of Elasticity (G′)

Oscillatory testing involves applying a small, nondestructive sinusoidal stress on the sample and measuring the strain output. The elastic modulus is a measurement of how elasticity or fluidity of the dough is derived from the dough's response to the applied stress.

The Theological properties of the dough are measured by preparing the dough by mixing in a DeLonghi Household Food Processor, Model Original 4.C, at low speed for 50-60 seconds. After mixing, the dough is sheeted using a conventional milling machine to a thickness of from about 0.021 inches to about 0.025 inches. The mill rolls are about 2 meters in length×0.75 meter in diameter.

A Control Stress Rheometer (CSL² 100) (TA Instruments Inc., New Castle Del.) is used to measure G′ and G″. The dynamic testing is performed with a 4 cm cross-hatch parallel plate at 32.2° C. This is the average temperature at which the dough is sheeted out between the rollers.

A sample is placed on the bottom plate and the gap is zeroed by lowering the top plate to 80% compression of the original thickness of the dough piece (˜0.1 mm). The sample is further analyzed in accordance with the test method described in U.S. Pat. No 6,228,414 at Column 16, line 8.

Tensile Strength

The tensile test is a measurement of the peak tension force and the elastic modulus of a sheet strip. The tensile strength is read as the maximum peak force (gf) of a graph obtained from force against distance. This test is designed to measure the strength, elasticity and extensibility of the dough sheet. The tensile strength is an average of 10 repetitions of each test.

This test is conducted using a Texture Analyzer (TA-XT2) from Texture Technologies Corp. This instrument utilizes a software called XT.RA Dimensions. This test utilizes 2 parallel friction rollers with a distance between the upper and lower rig arms set at 6 cm.

The dough sheet is cut into a strip 3 cm in width by 60 cm in length. The bottom of the sheet strip is placed into the lower rig arm slot that is attached to the test bed. The strip is wound 5 revolutions and tightened enough to hold the strip. The top part of the sheet strip is attached to a similar rig slot in a upper arm that is attached to the load cell in the front of the probe carrier. Once the dough is taut between the rig arms, the measurement is begun by moving the rig arms upward at a present fixed rate 10 mm/sec and set to travel 75 mm. Once the 5 g trigger force is attained the graph proceeds to plot the effect on the dough sheet under tension. When the elastic limit is exceeded, the dough strip breaks. The maximum peak force is recorded.

### EXAMPLES

The following examples illustrate the present invention but are not meant to be limiting thereof.

### Examples 1-6

Doughs are prepared from six different formulations:

| Formula # | 1 | 2 | 3 | 4 | 5 | 6 |
|---|---|---|---|---|---|---|
| Potato Flakes % | 47.9 | 43.4 | 47.6 | 47.2 | 43.1 | 42.8 |
| Wheat Starch % | 5.2 | 4.8 | 5.2 | 5.2 | 4.8 | 4.8 |
| Corn Meal % | 7.9 | 7.1 | 7.9 | 7.9 | 7.1 | 7.1 |
| Maltodextrin % | 4.6 | 4.2 | 4.6 | 4.6 | 4.2 | 4.2 |
| Added Potato Fiber % | 0 | 0 | 0.3 | 0.7 | 0.3 | 0.6 |
| (Paselli FPF ®) | | | | | | |
| Water % | 33.9 | 40 | 33.9 | 33.9 | 40 | 40 |
| Emulsifier % | 0.5 | 0.5 | 0.5 | 0.5 | 0.5 | 0.5 |

| Formula # / | | | | | | |
|---|---|---|---|---|---|---|
| Dough Properties | 1 | 2 | 3 | 4 | 5 | 6 |
| Sheet strength (gf) | 189.9 | 121.5 | 194 | 156.6 | 126.6 | 152.4 |
| Extensibility (mm) | 18.56 | 37 | 31.5 | 48.2 | 46.7 | 58.5 |
| Firmness (gf/mm) | 221 | 267.5 | 382.9 | 450.6 | 353.6 | 397.2 |
| Dough Elasticity (G′) | 85 | 30 | 50 | 50 | 25 | 10 |
| (KPa) | | | | | | |

The dough is prepared by mixing the ingredients in a DeLonghi Household Food Processor, Model Original 4.C, at low speed for 50-60 seconds. After mixing, the dough is sheeted using a conventional milling machine to a thickness of from about 0.021 inches to about 0.025 inches. The mill rolls are about 0.2 meters in length by about 0.75 meters in diameter.

### Incorporation by Reference

All of the aforementioned patents, publications, and other references are herein incorporated by reference in their entirety.

What is claimed:

1. A dough comprising:
(a) from about 0.1 % to about 4% added potato fiber;
(b) from about 35% to about 85% starch-based material; and
(c) from about 10% to about 50% added water.

2. The dough of claim 1, wherein said added potato fiber comprises from about 2% to about 13% protein.

3. The dough of claim 2, wherein said dough has a sheet strength of from about 60 gf to about 300 gf.

4. The dough of claim 3, wherein said dough has an extensibility of from about 15 mm to about 80mm.

5. The dough of claim 4, wherein said dough has a firmness of from about 200 gf/mm to about 650 gf/mm.

6. The dough of claim 5, wherein said dough has a G′ of from about 7 KPa to about 50 KPa.

7. A snack product made by a method comprising:
(a) providing the dough of claim 1;
(b) forming a snack piece from the dough; and
(c) cooking the snack piece to form said snack product.

8. The snack product of claim 7, wherein said snack product is a fabricated chip.

9. A snack product made by a method comprising:
(a) providing the dough of claim 6;
(b) forming a snack piece from the dough; and
(c) cooking the snack piece to form said snack product.

10. The snack product of claim 9, wherein said snack product is a fabricated chip.

11. A dough comprising:
(a) from about 0.1% to about 30% added potato fiber, wherein said added potato fiber comprises from about 30% to about 80% starch;
(b) from about 35% to about 85% starch-based material; and
(c) from about 10% to about 50% added water.

12. The dough of claim 12, wherein said added potato fiber comprises from about 2% to about 13% protein.

13. The dough of claim 12, wherein said dough has a sheet strength of from about 60 gf to about 300 gf.

14. The dough of claim 13, wherein said dough has an extensibility of from about 15 mm to about 80 mm.

15. The dough of claim 14, wherein said dough has a firmness of from about 200 gf/mm to about 650 gf/mm.

16. The dough of claim 15, wherein said dough has a G′ of from about 7 KPa to about 50 KPa.

17. A snack product made by a method comprising:
(a) providing the dough of claim 11;
(b) forming a snack piece from the dough; and
(c) cooking the snack piece to form said snack product.

18. The snack product of claim 17, wherein said snack product is a fabricated chip.

19. A snack product made by a method comprising:
(a) providing the dough of claim 16;
(b) forming a snack piece from the dough; and
(c) cooking the snack piece to form said snack product.

20. The snack product of claim 19, wherein said snack product is a fabricated chip
